(19) United States
(12) Patent Application Publication
(10) Pub. No.: US 2015/0092420 A1
(43) Pub. Date: Apr. 2, 2015

(54) OPTICAL SYSTEM EMPLOYING A CERAMIC REFLECTOR WITH AN ELECTRODE-LESS BULB FOR ILLUMINATION IN HIGH OUTPUT APPLICATIONS

(71) Applicant: Hive Lighting Inc., Los Angeles, CA (US)

(72) Inventors: Jonathan Edward Miller, Los Angeles, CA (US); Robert Rutherford, Santa Monica, CA (US); Jaime Emmanuelli, Temple City, CA (US)

(21) Appl. No.: 14/504,035

(22) Filed: Oct. 1, 2014

Related U.S. Application Data
(60) Provisional application No. 61/886,001, filed on Oct. 2, 2013.

(51) Int. Cl. F21V 7/00; F21V 13/04

(52) U.S. Cl. CPC F21V 7/00; F21V 13/04
USPC 362/293; 362/296.01; 362/308; 362/309; 29/592.1

(57) ABSTRACT

An optical system comprising a non-specular ceramic reflector surrounding one or more electrode-less bulbs containing a fill that forms a light-emitting plasma when excited with radio frequency, to be used in a fixture for illuminating subjects, for the purpose of high output lighting, such as lighting for image capture, horticulture, stadium, port, roadway, construction and area lighting. This ceramic reflector generates a uniform lambertian reflection specifically evening out the light emission from the electrode-less bulb producing a uniform beam of light with a spread between about 1 to about 300 degrees. This ceramic reflector greatly increases the amount of light falling on a given subject in comparison to the fixture without said reflector system. The beam of light created by this optical system may then be altered by the fixture by using a combination of further optical elements including but not limited to one or more lenses, one or more additional reflectors, one or more mirrors and one or more filter materials, which may be mounted inside our outside of the light fixture. The lenses and/or filters can be adjusted in distance from the light elements, for example by moving the lenses/filters into different positions on the fixture, to alter characteristics of the emitted light. Focal lenses, diffusion lenses, reflectors and color filters may be used individually or in combination.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

The present application claims priority under 35 U.S.C. 119(e) to U.S. Provisional Patent Application No. 61/886001 filed Oct. 2, 2013, the entire contents of which are hereby incorporated by reference and should be considered a part of this specification

### BACKGROUND

1. Field

The present invention is directed to an optical system as it relates to a lighting fixture, and more particularly to an optical system that can be used in a lighting fixture for high output lighting, specifically but not limited to use in image capture, horticulture, stadium, port, roadway, construction and area lighting.

2. Description of the Related Art

Lighting systems are an integral part of multiple industries; specifically high output lighting is required for specific industries such as image capture, horticulture, stadium, port, roadway, construction and area lighting. High output lighting can be understood as lighting fixtures that provide acceptable levels of illumination for a variety of activities from a distance of about 25 ft or greater, or high levels of illumination from distances under about 25 ft. This can be understood to be separate and distinct from common low output lighting fixtures designed for domestic and office use internal to structures with average ceiling heights of 8-15 ft.

Proper illumination from a distance is necessary for a variety of industries. In image capture when filming movies, television shows, or commercials, when shooting video clips, or when taking still photographs, whether such activities are carried out indoors or outdoors and proper exposure requires a variety of light levels to be achieved from a variety of distances between a lighting fixture and the subject. A specific illumination effect might also be desired for live performances on stage or in any other type of setting where bringing the fixture closer to the subject is impossible. Proper illumination from a distance is also necessary for stadium lighting, area, and roadway lighting where light fixtures cannot impede the view of participants, attendees and drivers, respectively. For port and construction lighting, fixtures must rise above the heights of large equipment, while effectively directing light to surfaces at which technicians are working, and beyond.

Proper illumination from high output fixtures used from distances less than 25 ft to create illumination levels higher than average domestic levels of illumination are also necessary for a variety of industries. In the image capture industries when filming movies, television shows, or commercials, when shooting video clips, or when taking still photograph to create acceptable illumination levels, high output lighting may be used to rival or balance daylight from the sun, or provide light levels needed for certain technical requirements like low sensitivity capture equipment, high shutter speeds or high frame rates. In other technical industries, high illumination levels may be need to create daylight like scenarios in indoor or controlled settings, for testing durability and light sensitivity of equipment. In horticultural applications, growing plant life in artificial settings requires the use of light sources to create the needed conditions for photosynthesis, where higher light levels may result in a more successful growth cycles and yields.

A primary purpose of such a lighting fixture is to illuminate a subject to allow proper image capture or achieve a desired effect. Often it is desirable to obtain even lighting that minimizes shadows on or across the subject. It may be necessary or desirable to obtain lighting that has a certain shape, tone, color, or intensity. It may also be necessary or desirable to have certain lighting effects, such as colorized lighting, strobed lighting, gradually brightening or dimming illumination, or different intensity illumination in different fields of view.

Because of the varied settings in which lighting fixtures for high output lighting are used, the conventional practice in the related industries are for a lighting system, when needed, to be custom designed for high output lighting. A lighting apparatus specially adapted for general illumination and low output lighting is generally not suitable for the special needs of high output lighting in industries such as image capture, horticulture, stadium, port, roadway, construction and area lighting, because the lighting needs in these fields differs substantially from what is offered by a general or low output lighting apparatus. Indeed, general or low output lighting apparatuses are generally designed for levels of illumination, at a distance, which are too minimal for the industries requiring high output lighting fixtures.

Electrode-less bulbs containing a fill that forms light-emitting plasma are a known light source and can be used as a light source in a variety of fixtures. An integral part of any fixture designed for high output lighting is its optical reflector system. This reflector system is designed to create even lighting with unique properties, such as greater output and or the ability create specific shapes and lighting effects. Since electrode-less bulbs have unique properties they need unique reflector systems to make them applicable for high output lighting.

Current reflectors for low output lighting do not produce a significant increase in the output compared to reflectors used for high output lighting. Also current reflectors when not designed for high output lighting may produce light where the quality of the light emitted from the fixture is negatively affected, such as changing the color and/or evenness of the projected beam light and/or creating multiple shadows, or inferior reflectivity, as well as other undesired effects. There are current optical reflector systems designed for high output lighting for previously existing bulbs such as incandescent and metal halide bulbs, but because of the unique properties of an electrode-less bulb and light emitting plasma, resulting from such elements as the specific arc size of an electrode-less bulb, the physical size as well as the uneven emission of the light from many plasma sources, their optical design is incompatible.

Reflector materials commonly in use in high output lighting are aluminum and dichroic glass. These materials may be formed, treated and given a variety of coatings to create the desired attributes such as color, output, and angle in the beam of light formed. However these existing reflectors and materials were not designed with the properties of light-emitting plasma in mind. The smaller size of the electrode-less bulb and the arc in comparison to the great deal of lumens emitted results in a greater propensity for spectral highlights making many aluminum reflectors unable to function as efficiently and to create an even light distribution. Also the small size of the bulb, the high temperatures required for the bulb's operation to maintain the formation of a plasma, and its small arc requires reflectors to be much smaller and closer to point source origin, making it impossible for many of the coatings common amongst existing reflectors in use as such coatings would degrade at the operating temperatures associated with electrode-less bulb operation.

### SUMMARY

The invention is generally directed in one aspect to a novel and unique reflector system for an electrode-less bulb. This reflector system being comprised of a high efficiency diffuse ceramic material is then paired with one or more electrode-less bulbs containing a fill that forms a light-emitting plasma when excited with radio frequency, to be used in a fixture for illuminating subjects, for the purpose of high output lighting, such as lighting for image capture, stadium, port, roadway, construction and area lighting.

It would be advantageous to provide a lighting fixture using an electrode-less bulb that has an optical system, particularly in the form of a reflector that is designed for use in high output lighting that will maximize the benefits of light-emitting plasma and produce large amounts of continuous, flicker free light using less power, and generating less heat that may find use in a variety of applications. It would further be advantageous to provide a lighting fixture using an electrode-less bulb with a specific optical system, with a reflector made from a new material, specifically a ceramic, which allows the fixture to produce large amounts of continuous, flicker free light using less power, and generating less heat that is well suited for use in high output lighting for image capture, horticulture, stadium, port, roadway, construction and area lighting, that overcomes one or more of the foregoing disadvantages, drawbacks, or limitations as described in the background. It would further be advantageous if that ceramic reflector projected light with an even lambertian field, a singular shadow, and all, substantially all or the vast majority of all the lumens produced by the bulb in the desired direction.

This ceramic reflector will create a non-specular, lambertian beam of light, which can then be paired with a series of optical systems, such as lenses, additional reflectors, mirrors and filters, both inside and outside a lighting fixture. The resulting luminaire will produce a more even and controllable beam of light as well as more efficiently direct lumens onto the intended subject for illumination.

In accordance with one aspect of the invention, an optical system is provided. The optical system comprises reflector made of a non-specular, highly reflective ceramic material. The optical system also comprises an electrode-less bulb coupleable with the reflector to produce a homogenous and lambertian beam of light, the electrode-less bulb filled with a gas that forms a light-emitting plasma when excited.

Optionally, one or more lenses are operatively coupleable with one or both of the reflector and electrode-less bulb to alter the characteristics of beam of light produced by said optical system. The one or more lenses can be selected from the group consisting of a Fresnel lens, a lenticular lens, a convex lens, a bi-convex lens and a plano-convex lens. Optionally, a highly reflective mirrored surface can be operatively coupled to one or both of the reflector and electrode-less bulb, the mirrored surface configured to redirect the beam of light.

Optionally, one or more colored filters or dimmers, or diffusion are operatively coupled to one or both of the reflector and the electrode-less bulb to alter one or both of the characteristics and output of the beam of light produced by said optical system. Optionally, a highly reflective mirrored surface can be operatively coupled to one or both of the reflector and electrode-less bulb, the mirrored surface configured to redirect the beam of light.

In accordance with another aspect of the invention, an optical system is provided. The optical system comprises at least one reflector body having a proximal opening and a distal opening and an inner circumferential wall between the proximal and distal openings that defines a space within the body. The distal opening is larger than the proximal opening and the proximal opening is defined at least in part by a lip that extends inward from the inner circumferential wall and has a chamfered edge. The inner circumferential wall is made of a non-specular highly reflective ceramic material. The optical system further comprises an electrode-less bulb coupleable with the at least one reflector body to produce a homogenous and lambertian beam of light. The electrode-less bulb is configured to extend at least partially through the proximal opening and into the space defined by the inner circumferential wall. The electrode-less bulb is filled with a gas that forms a light-emitting plasma when excited.

In accordance with another aspect of the invention, a method of making a high-output optical system is provided. The method comprises selecting one of a plurality of interchangeable reflector bodies, each reflector body having a proximal opening and a distal opening and an inner circumferential wall between the proximal and distal openings that defines a space within the body, wherein the distal opening is larger than the proximal opening and the proximal opening is defined at least in part by a lip that extends inward from the inner circumferential wall and has a chamfered edge, the inner circumferential wall made of a non-specular highly reflective ceramic material. The method also comprises inserting an electrode-less bulb at least partially through the proximal opening so that the electrode-less bulb extends into the space defined by the inner circumferential wall, the electrode-less bulb filled with a gas that forms a light-emitting plasma when excited. The method also comprises operating the electrode-less bulb, once coupled to said selected reflector body to produce a homogenous and lambertian beam of light, wherein a distance from the electrode-less bulb to the chamfered edge of the proximal opening is substantially the same for the plurality of interchangeable reflector bodies.

These and other objects, features and advantages of the present invention will become more apparent from the detailed description of the preferred embodiment when read in conjunction with the drawings.

### BRIEF DESCRIPTION OF THE DRAWINGS

FIGS. 1A and 1B show a schematic front end view and a schematic cross-sectional side view, respectively, of one embodiment of a non-specular, high efficiency diffuse ceramic reflector with a beam angle of 50 degrees for use in an optical system.

FIGS. 2A and 2B show a schematic front end view and a schematic cross-sectional side view, respectively, of another embodiment of a non-specular, highly efficiency diffuse, ceramic reflector, with a beam angle of 110 degrees for use in an optical system.

FIG. 3 is a schematic view of one embodiment of an optical system having one possible non-specular, high efficiency diffuse ceramic reflector in combination with one possible electrode-less bulb containing a fill that when excited forms a light emitting plasma.

FIG. 4 is a schematic view of the optical system of FIG. 3 in combination with a flat borosilicate glass lens for the purpose of trapping both ultra-violet and infrared radiation while allowing all or most of the emission from the light emitting plasma in the visible electromagnetic spectrum to pass through the flat borosilicate glass lens.

FIG. 5 is a schematic view of one embodiment of an optical system combining one embodiment of a ceramic reflector with an electrode-less bulb and a Fresnel lens. The Fresnel lens' distance from the reflector and bulb can be adjustable allowing the beam of light to change, effectively spotting and flooding the light coming from the luminaire in which the optical system was integrated.

FIG. 6 is a schematic view of one embodiment of an optical system combining one embodiment of a ceramic reflector with an electrode-less bulb, a bi-convex lens and a lenticular lens to allow both the spread and focus the beam of light further depending on the combination.

FIG. 7 is a schematic view of one embodiment of an optical system combining one embodiment of a ceramic reflector with an adjustable glass dichroic mirror to redirect the beam of light with virtually no light loss to in a desired direction between 0-90 degrees from the original beam angle of the lamp.

### DETAILED DESCRIPTION

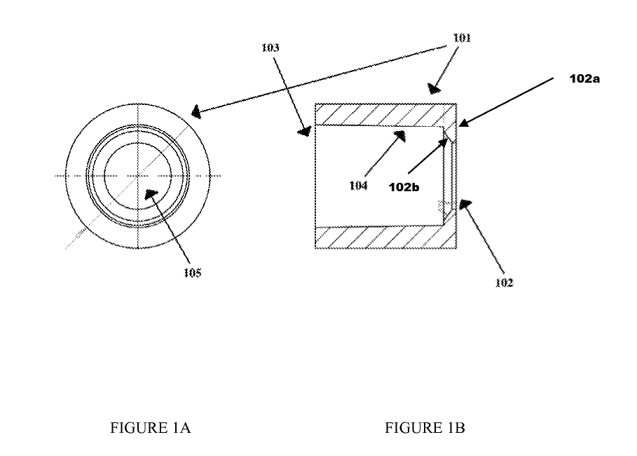

FIGS. 1A-1B illustrate one embodiment of a reflector for an optical system for high output lighting, specifically a reflector 101 made of a non-specular, highly reflective ceramic material. This reflector 101 may be generally cylindrical in shape and would surround an electrode-less bulb, where the bulb would be inserted into the reflector through a proximal circular opening 102. In the illustrated embodiment, the proximal opening 102 can have a diameter of about 16.2 mm with a 110 degree slope. The light emitted from this electrode-less bulb would exit through a distal circular opening 103 at an opposite end of the reflector 101 from the proximal opening 102. The distal opening 103 can be larger than the proximal opening 102. In the illustrated embodiment, the distal opening 103 can have a diameter of about 25 mm. While in the illustrated embodiment the proximal and distal openings 102, 103 are circular, and the reflector 101 is cylindrical, multiple geometric shapes such as hexagonal, rectangular and conical reflectors could be used to create different effects and efficiencies in the resulting projected beam of light. In one embodiment, the distance from the electrode-less bulb to the edge of the reflector opening 102 is substantially constant among the different reflectors 101 (e.g., said distance from the electrode-less bulb to the edge of the reflector opening 102 is substantially the same for the 50 degree reflector, the 110 degree reflector, etc.) to allow the resulting lighting assembly to provide a desired tight or focused beam of light. In FIGS. 1A-1B the reflector's 101 internal wall 104 (e.g. internal circumferential wall) can be composed of a 95-99.9% reflective uncoated ceramic surface material composed of high purity metal oxides free of transition metals and their compounds with virtually no specular reflection. One such highly reflective material suitable for this application is the product Accuflect™ produced by the Accuratus company of Phillipsburg, N.J. The proximal opening 102 is defined by a lip 102a that extends inwardly from the internal wall 104. The lip 102a can have a chamfered edge 102b.

With continued reference to FIGS. 1A-1B, the reflector 101 can have a height of about 34 mm and would create a beam of light projected from its opening 103 with a beam angle of about 50 degrees when properly mounted to an electrode-less bulb centered 105 within the non-specular, highly reflective ceramic material. Advantageously, this 50-degree beam of light would be homogenous and lambertian in nature and would create a singular shadow.

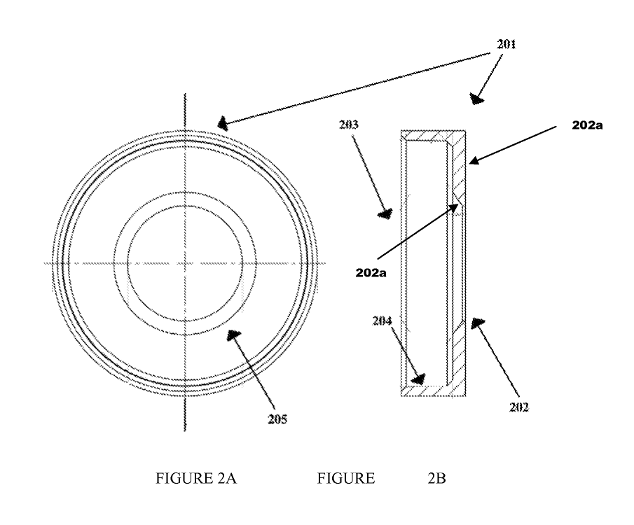

In further detail FIGS. 2A-2B illustrate another embodiment of a reflector for an optical system for high output lighting, specifically a reflector 201 made of a non-specular, highly reflective ceramic material. This reflector 201 may be cylindrical and would surround an electrode-less bulb, the bulb would be inserted into the reflector through a proximal circular opening 202, and the light emitted from this electrode-less bulb would exit through a distal circular opening 203 that is larger than the proximal opening 202. While in the illustrated embodiment the proximal and distal openings 202, 203 are circular and the reflector 201 is cylindrical, multiple geometric shapes such as hexagonal, rectangular and conical reflectors could be used to create different effects and efficiencies in the resulting projected beam of light. In FIGS. 2A-2B, the reflector's 201 internal walls 204 (e.g., internal circumferential wall) can be made of a 95-99.9% reflective uncoated ceramic surface material composed of high purity metal oxides free of transition metals and their compounds with virtually no specular reflection. The reflector 201, in the illustration in FIGS. 2A-2B would create a beam of light projected from its distal opening 203 with a beam angle of about 110 degrees when properly mounted to an electrode-less bulb centered 205, within the non-specular, highly reflective ceramic material. Advantageously, this 110-degree beam of light would be homogenous and lambertian in nature. The proximal opening 202 is defined by a lip 202a that extends inwardly from the internal wall 204. The lip 202a can have a chamfered edge 202b.

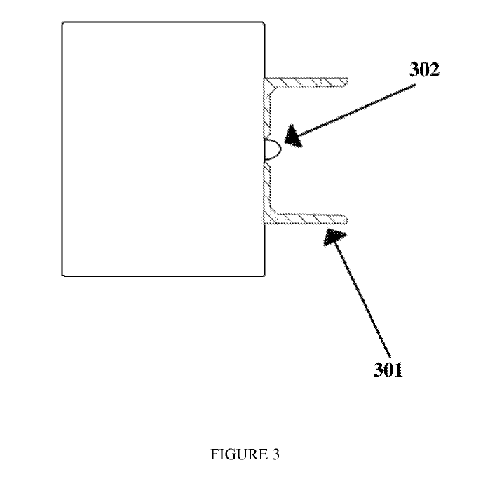

In more detail FIG. 3 is an illustration of one embodiment of an optical system for high output lighting combining a reflector 301 made of a non-specular, highly reflective ceramic material and an electrode-less gas filled bulb 302 containing a fill that forms a light-emitting plasma when excited with radio frequency. The reflector 301 can in one embodiment be similar to the reflector 101. In another embodiment, the reflector 301 can be similar to the reflector 201. Combined, the reflector 301 and electrode-less gas filled bulb 302 form a unique optical system for high output illumination.

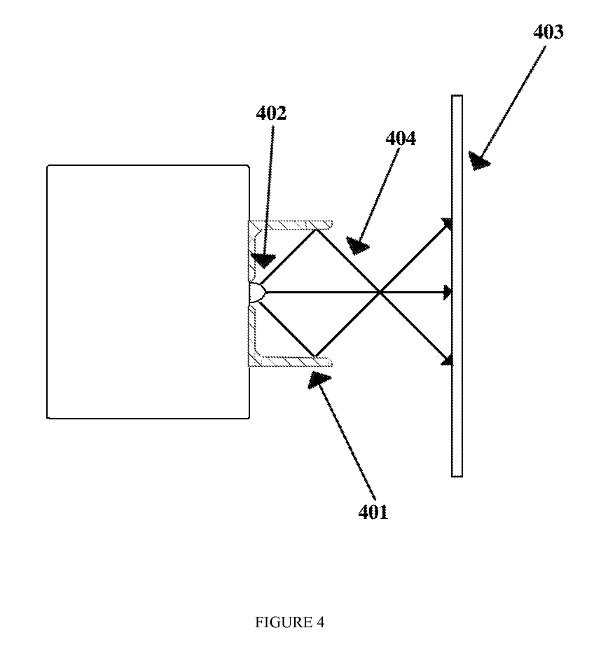

FIG. 4 illustrates an embodiment of an optical system combing a reflector 401 made of a non-specular, highly reflective ceramic material. In this preferred embodiment this reflector 401 surrounds an electrode-less bulb 402, light 404 is emitted from this bulb, and is reflected by the ceramic reflector 401 and projected in a 50-degree lambertian beam towards a flat lens 403. The reflector 401 can in one embodiment be similar to the reflector 101. This lens 403 may be made of either glass or plastic, and may be translucent or transparent in nature designed to transmit all or some of the light projected from the reflector 401.

In one embodiment as illustrated in FIG. 4 this lens 403 is made of transparent borosilicate glass of 3 mm thickness or greater, designed to block the transmission of both infrared and ultraviolet radiation while allowing the vast majority of light 404 in the visible spectrum to pass through the lens 403 unaltered.

In another embodiment, the lens 403 is made of a material such as a dichroic glass or dyed plastic designed to block the transmission of the electrode-less bulb's 402 spectrum to result in a specific color temperature as measured in degrees Kelvin. Such commonly desired color temperatures as 2900 degrees Kelvin, 3200 degrees Kelvin, 4800 degrees Kelvin, 5600 degrees Kelvin, 6000 degrees Kelvin and 6500 degrees Kelvin could be achieved, though other color temperatures are possible.

In another embodiment, the lens 403 is made of a dichroic glass or dyed plastic designed to block or limit the transmission of the light 404 emitted from the electrode-less bulb 402 to result in a very limited spectrum, defined by the vast majority of light limited to a specific nanometer in the electromagnetic spectrum. In this embodiment, the lens 402 is made of a material such as dichroic glass or dyed plastic designed to limit the transmission of the optical system to commonly desired nanometers for specific industries, such as 420 nm or 450 nm or 525 nm or 650 nm.

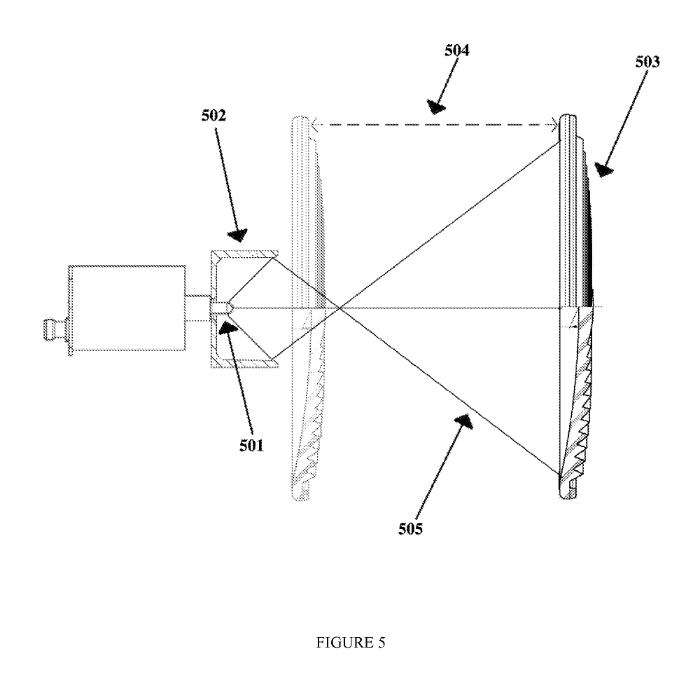

FIG. 5 illustrates one embodiment of an optical system combining a reflector 501 made of a non-specular, highly reflective ceramic material. In the illustrated embodiment, the reflector 501 surrounds an electrode-less bulb 502 and light 505 emitted from this bulb is reflected by the ceramic reflector 501 and projected in a 50-degree lambertian beam towards a Fresnel lens 503. While the orientation and distance between bulb 502 and reflector 501 are fixed, the distance between this Fresnel lens 503 and the bulb 502 and reflector 501 can be adjusted 504 to create a spotting at flooding effect from the resulting beam of light collimated and projected from the Fresnel lens 503. This adjusted distance 504 can be achieved either by moving the Fresnel lens 503 in relationship to the bulb 502 and reflector 501 or by moving the bulb 502 and reflector 501 in relationship to the Fresnel lens 503 or by moving some combination of both.

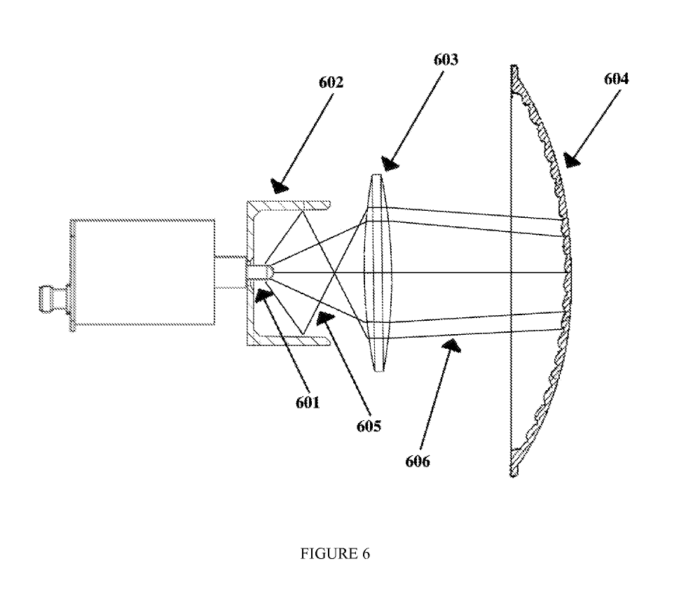

FIG. 6 shows an embodiment of an optical system combining a reflector 602 made of a non-specular, highly reflective ceramic material and an electrode-less bulb containing a fill that when excited with radio frequency creates a light-emitting plasma. In this embodiment, this reflector 602 surrounds an electrode-less bulb 601, light 605 is emitted from this bulb 601, and is reflected by the ceramic reflector 602 and projected in a 50-degree lambertian beam towards a biconvex lens 603 which collimates the light 606 into a lenticular lens 604. In the illustrated embodiment, the biconvex lens 603 would focus the 50-degree beam angle created by the reflector 602 to a desired smaller beam angle. In other embodiments, different lenticular lens 604 can be used to spread the collimated light 606 from the biconvex lens 603 into a different desired beam angle.

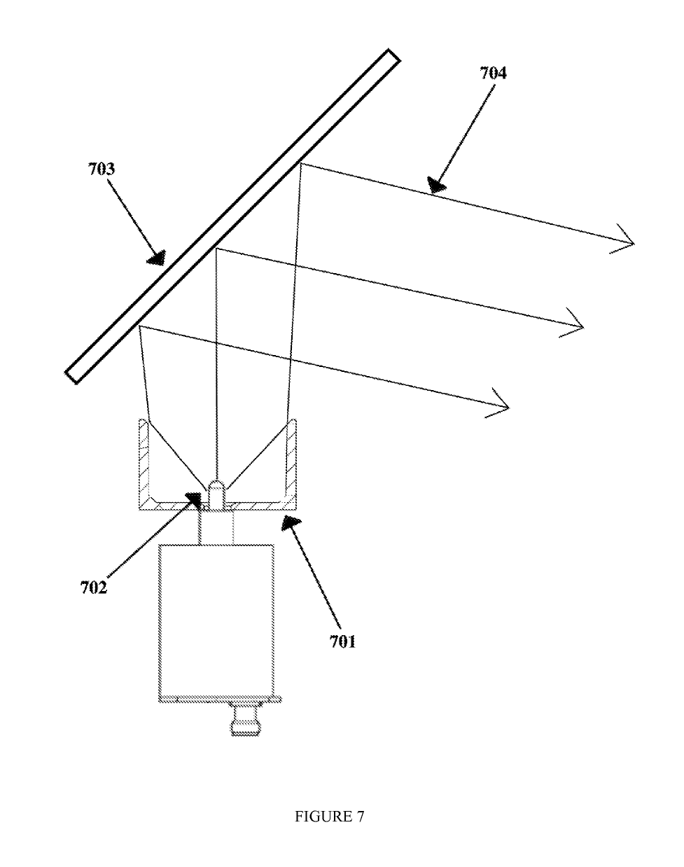

FIG. 7 illustrates an embodiment of an optical system combining a reflector 701 made of a non-specular, highly reflective ceramic material with an electrode-less bulb 702 containing a fill that when excited with radio frequency creates a light-emitting plasma. In this preferred embodiment this reflector 701 surrounds an electrode-less bulb 702, light 704 is emitted from this bulb 702, and is reflected by the ceramic reflector 701 and projected onto a mirrored surface 703. In this embodiment the mirrored surface 703 can be made of a material substrate such as glass, metal or plastic with the resulting mirror 703 having virtually no light loss. The mirror 703 is adjustable allowing for redirection of the beam of light with virtually no light loss in a desired direction between 0-90 degrees from the original beam angle of the lamp.

Various embodiments have been described as having particular utility to high output lighting for various applications in industries such as image capture, horticulture, stadium, port, roadway, construction and area lighting. However, the various embodiments may find utility in other areas as well, such as, for example, automated manufacturing, machine vision, event lighting and the like.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a sub combination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. An optical system, comprising:
a reflector made of a non-specular, highly reflective ceramic material; and
an electrode-less bulb coupleable with the reflector to produce a homogenous and lambertian beam of light, the electrode-less bulb filled with a gas that forms a light-emitting plasma when excited.

2. The optical system of claim 1, further comprising one or more lenses operatively coupleable with one or both of the reflector and electrode-less bulb to alter the characteristics of beam of light produced by said optical system.

3. The optical system in claim 2, where the one or more lenses are selected from the group consisting of a Fresnel lens, a lenticular lens, a convex lens, a bi-convex lens and a plano-convex lens.

4. The optical system of claim 2, further comprising a highly reflective mirrored surface operatively coupled to one or both of the reflector and electrode-less bulb, the mirrored surface configured to redirect the beam of light.

5. The optical system of claim 1, further comprising one or more colored filters or dimmers, or diffusion materials configured to alter one or both of the characteristics and output of the beam of light produced by said optical system.

6. The optical system of claim 5, wherein the one or more filters comprises one or more of an Ultraviolet filter, an Infrared filter, and a filter which creates a color temperature between 500 K-50,000 K degrees or range of the electromagnetic spectrum between 200-800 nanometers.

7. The optical system of claim 5, further comprising a highly reflective mirrored surface operatively coupled to one or both of the reflector and electrode-less bulb, the mirrored surface configured to redirect the beam of light.

8. The optical system of claim 1, further comprising a highly reflective mirrored surface operatively coupled to one or both of the reflector and electrode-less bulb, the mirrored surface configured to redirect the beam of light.

9. The optical system of claim 8, wherein the highly reflective mirrored surface is made of glass, plastic or metal substrate.

10. An optical system, comprising:
at least one reflector body having a proximal opening and a distal opening and an inner circumferential wall between the proximal and distal openings that defines a space within the body, wherein the distal opening is larger than the proximal opening and the proximal opening is defined at least in part by a lip that extends inward from the inner circumferential wall and has a chamfered edge, the inner circumferential wall made of a non-specular highly reflective ceramic material; and
an electrode-less bulb coupleable with the at least one reflector body to produce a homogenous and lambertian beam of light, the electrode-less bulb configured to extend at least partially through the proximal opening and into the space defined by the inner circumferential wall, the electrode-less bulb filled with a gas that forms a light-emitting plasma when excited.

11. The system of claim 10, wherein the at least one reflector body is generally cylindrical and the inner circumferential wall is cylindrical.

12. The system of claim 10, wherein the at least one reflector body comprises a plurality of interchangeable reflector bodies, wherein a distance from the electrode-less bulb to the chamfered edge of the proximal opening is substantially the same for the plurality of interchangeable reflector bodies.

13. The system of claim 12, wherein each of the plurality of interchangeable reflector bodies is configured to project a light beam from the electrode-less bulb at a different beam angle.

14. The optical system of claim 10, further comprising one or more lenses operatively coupleable with one or both of the reflector body and electrode-less bulb to alter the characteristics of beam of light produced by said optical system.

15. The optical system in claim 14, where the one or more lenses are selected from the group consisting of a Fresnel lens, a lenticular lens, a convex lens, a bi-convex lens and a plano-convex lens.

16. The optical system of claim 14, further comprising a highly reflective mirrored surface operatively coupled to one or both of the reflector body and electrode-less bulb, the mirrored surface configured to redirect the beam of light.

17. The optical system of claim 10, further comprising one or more colored filters or dimmers, or diffusion materials configured to alter one or both of the characteristics and output of the beam of light produced by said optical system.

18. A method of making a high-output optical system, comprising:
selecting one of a plurality of interchangeable reflector bodies, each reflector body having a proximal opening and a distal opening and an inner circumferential wall between the proximal and distal openings that defines a space within the body, wherein the distal opening is larger than the proximal opening and the proximal opening is defined at least in part by a lip that extends inward from the inner circumferential wall and has a chamfered edge, the inner circumferential wall made of a non-specular highly reflective ceramic material; and
inserting an electrode-less bulb at least partially through the proximal opening so that the electrode-less bulb extends into the space defined by the inner circumferential wall, the electrode-less bulb filled with a gas that forms a light-emitting plasma when excited; and
operating the electrode-less bulb, once coupled to said selected reflector body to produce a homogenous and lambertian beam of light,
wherein a distance from the electrode-less bulb to the chamfered edge of the proximal opening is substantially the same for the plurality of interchangeable reflector bodies.

19. The method of claim 18, further comprising operatively coupling one or more lenses with one or both of said selected reflector body and electrode-less bulb to alter the characteristics of beam of light produced by said optical system.

20. The optical system in claim 19, where the one or more lenses are selected from the group consisting of a Fresnel lens, a lenticular lens, a convex lens, a bi-convex lens and a plano-convex lens.
